(19) United States
(12) Patent Application Publication
(10) Pub. No.: US 2005/0234200 A1
(43) Pub. Date: Oct. 20, 2005

(54) Thermally regenerable salt sorbents

(75) Inventors: Roger E. Johnson, Reno, NV (US); Gerald Colombo, Myrtle Creek, OR (US)

Correspondence Address: BEYER WEAVER & THOMAS LLP, P.O. BOX 70250, OAKLAND, CA, 94612-0250, US

(73) Assignee: UMPQUA Research Company

(21) Appl. No.: 10/856,119

(22) Filed: May 28, 2004

Related U.S. Application Data
(60) Provisional application No. 60/563,891, filed on Apr. 19, 2004.

(51) Int. Cl. C08F 2/00

(52) U.S. Cl. 525/242

(57) ABSTRACT

An improved heterogenous hybrid thermally regenerable salt sorbent resin is provided. The salt sorbent resin comprises a macroporous host copolymer and a crosslinked guest copolymer having, respectively, weak acid groups and weak base groups. The salt sorbent resin is formed from a precursor heterogenous hybrid resin having a crosslinked guest copolymer formed from a polyunsaturated monomer and a monoethylenically unsaturated monomer containing a haloalkyl group.

### PRIORITY OF RELATED APPLICATION

The benefit of the provisional application Ser. No. 60/563,891, filed Apr. 19, 2004 pursuant to 35 USC 119(e) is hereby claimed.

The invention pertains to a thermally regenerable salt sorbent and use thereof for removing or reducing the concentration of dissolved salts contained in an aqueous fluid.

### BACKGROUND OF THE INVENTION

The invention utilizes hybrid resins which constitute a system of discrete weak acid and weak base resin particles. The hybrid resins comprise a macroporous copolymer, termed the “host”, which is at least filled in its macropores with a cross-linked copolymer of a different nature, termed the “guest”. Thus there is a location of one type of polymer in the pores and another type of polymer in the framework of the hybrid resin.

The term “hybrid” indicates that the resins have some of the characteristics or properties of both a gel and a macroporous copolymer, but also that they have distinct properties of their own. The pores of the macroporous host copolymer are typically filled with the guest copolymer utilizing varying percentages of crosslinking agent by introducing the guest copolymer or the guest copolymer-forming monomer components in varying amounts. The resins may also be prepared by filling the pores of the macroporous host copolymer with additional macroreticular copolymers in varying amounts with varying crosslinker contents or varying amounts of phase extender.

The host copolymer possesses a porous structure referred to as macroporous, which means it possesses a network of microscopic channels extended through the mass. While small, these channels are large in comparison with pores in a gel which are not visible, for example, in electronic photomicrographs. A typical macroporous (MP) copolymer has a surface area of at least about 1 m²/gm and pores larger than about 50-20 Å. Usually the MP copolymers are produced in bead form having a particle size of around 10-900 microns. Similar types of monomeric materials are used in preparing the MP host copolymer and the guest copolymer, but the preparation process is varied to impart different characteristics such as porosity to the different phases of the hybrid resins.

It has now been found according to the invention that by selection of a particular class of guest copolymers which are formed from haloalkylated-monomers, not only are unexpectedly superior characteristics obtained in forming a thermally regenerable salt sorbent resin, but also there is an advantage in the method of synthesis of the resins. The synthesis is not only simplified, but also made safer and, therefore, more commercially advantageous.

As used herein, the term “elution” refers to the removal of ions, both cations and anions, which have been loaded on to the resin during the absorption process. The term “regeneration” refers to restoration of the functional groups to the resin to the zwitterion form. These operations are each thermally activated and essentially simultaneously occur. Therefore, elution will necessarily also involve regeneration.

### SUMMARY OF THE INVENTION

A method is provided by the present invention for treating an aqueous fluid to substantially reduce the concentration of dissolved salts, that is, the cations and anions, contained therein comprising:
(a) contacting the fluid within a first temperature range with a mass of thermally regenerable hybrid resin having two relatively independently phases, the first phase comprising a host macroporous copolymer of a polyunsaturated monomer and a monoethylenically unsaturated monomer containing a weak acid group, and a second phase comprising a crosslinked guest copolymer of a polyunsaturated monomer and a monoethylenically unsaturated monomer a containing weak basic group; wherein the pores of the host macroporous copolymer of the first phase are at least partially filled with the guest copolymer of the second phase; and
(b) regenerating the hybrid resin by elution with a regenerant fluid within a second temperature range wherein the second temperature range is greater than the first temperature range.

The thermally regenerable hybrid resin is formed from a precursor resin. The precursor resin is formed by forming a crosslinked guest copolymer comprising a polyunsaturated monomer and a monoethylenically monomer containing a haloalkyl group in the presence of a host macroporous copolymer formed from a polyunsaturated monomer and a monoethylenically unsaturated monomer containing a functionality convertible to a weak acid group. The precursor resin formed is a hybrid copolymer containing a crosslinked macroporous host copolymer phase containing functionalities convertible to weak acid groups, having at least some of the pores filled with a crosslinked guest copolymer phase containing haloalkyl groups. The precursor resin is then formed into the thermally regenerable hybrid resin by treatment with a weak base to at least partially convert the haloalkyl groups to weak base groups to form a heterogenous hybrid weak base resin; and treating the heterogenous hybrid weak base resin with a hydrolyzing agent to thereby at least partially convert the funtionalities to weak acid groups to form a heterogenous hybrid thermally regenerable resin having two relatively independent phases, one phase comprising the host macroporous copolymer having weak acid groups, and the other phase comprising the crosslinked guest copolymer having weak base groups.

The thermally regenerable salt sorbent resins according to the present invention are useful for deionizing aqueous fluids, desalination, water purification, water softening, metals recovery and other applications requiring removal of ions from an aqueous source.

### BRIEF DESCRIPTION OF THE FIGURES

In the accompanying FIG. 1, there is shown a diagram of preferred synthetic method for producing the resins according to the present invention.

FIG. 2 is a graph of conductivity (a measure of total ion concentration) and hardness (a measure of calcium and magnesium ion concentration) vs. bed volume on loading a resin according to the invention, TRSS 36A.

FIG. 3 is a graph of the same parameters as shown in FIG. 2 on loading a known resin, GR40.

### DETAILED DESCRIPTION OF THE PREFERRED EMBODIMENTS

The thermally regenerable salt sorbent resins according to the present invention are particulates and contain both weakly acidic groups and weakly basic groups within the resin matrix. The resins are hybrid resins in the form of beads which have as a macroporous matrix a host copolymer of a polyunsaturated monomer containing weak acid groups with the macropores in the matrix being at least partially filled with the crosslinked guest copolymer of a polyunsaturated monomer and a monoethylenically unsaturated monomer containing weak basic groups.

The resin is made by polymerization of a mixture of guest copolymer precursor monomer or monomers and chain extenders in the presence of a host precursor macroporous copolymer. The resultant macroporous copolymer will be a precursor form in which the weak acid groups are protected functionalities, such as carboxylic acid esters, which are convertible to weak acids The precursor monomers of the guest copolymer bear functional groups which are precursors in that they are convertible to weak basic groups.

The backbone of the host macroporous copolymer will be a crosslinked copolymer of (1) a polyunsaturated monomer containing a plurality of non-conjugated ethylenic groups (CH₂═C—) and (2) a monoethylenically unsaturated monomer, either aromatic or aliphatic.

Suitable polyunsaturated monomers include divinylbenzene, divinyltoluenes, divinylnaphthalenes, diallyl phthalate, ethylene glycol diacrylate, ethylene glycol dimethacrylate, trimethylolpropane trimethacrylate, neopentyl glycol dimethacrylate, bis-phenol A dimethacrylate, pentaerythritol, tetra- and trimethacrylates, divinylxylene, divinylethylbenzene, divinylsulfone, divinylketone, divinylsulfide, allyl acrylate, diallyl maleate, diallyl fumarate, diallyl succinate, diallyl carbonate, diallyl malonate, diallyl oxalate, diallyl adipate, diallyl sebacate, divinyl sebacate, diallyl tartrate, diallyl silicate, triallyl tricarballylate, triallyl aconitate, triallyl citrate, triallyl phosphate, N,N′-methylenediacrylamide, N,N′-methylene dimethacrylamide, N,N′ethylenediacrylamide, trivinylbenzene, trivinylnaphthalene, polyvinylanthracenes and the polylallyl and polyvinyl ethers of glycol glycerol, pentaerythritol, resorcinol and the monothio- or dithio-derivatives of glycols.

A preferred polyunsaturated monomer is divinylbenzene (DVB).

Suitable monoethylenically unsaturated monomers for the macroporous host copolymer include esters of acrylic acid, such as methyl acrylate, ethyl acrylate, propyl acrylate, isopropyl acrylate, butyl acrylate, tert-butyl acrylate, ethylhexyl acrylate, cyclohexyl acrylate, isobornyl acrylate, benzyl acrylate, phenyl acrylate, alkylphenyl acrylate, ethoxymethyl acrylate, ethoxyethyl acrylate, ethoxypropyl acrylate, propoxymethyl acrylate, propoxyethyl acrylate, propoxypropyl acrylate, ethoxyphenyl acrylate, ethoxybenzyl acrylate, ethoxycyclohexyl acrylate, the corresponding esters of methacrylic acid, styrene, o-, m-, and p-methyl styrenes, and o-, m-, and p-ethyl styrenes, dimethyl itaconate, vinyl naphthalene, vinyl toluene and vinylnaphthalene. A class of monomers of particular interest consists of the esters of acrylic and methacrylic acid with C₁-C₁₀ aliphatic alcohol.

The formation of the macroporous host copolymer will result in a precursor copolymer which will contain pendant functionalities which can be converted to weak acids. For example, referring to FIG. 1, if an ester of acrylic acid is used as the monoethylenically unsaturated monomer, the resultant host precursor copolymer will contain carboxylic acid ester groups which can later be converted to carboxylic acid groups by hydrolysis.

The crosslinked guest precursor copolymer will be formed from a polyunsaturated monomer and a monoethylenically unsaturated monomer containing functional groups which can be converted to weak bases. Suitable polyunsaturated monomers used to form the guest precursor copolymer are the same as the polyunsaturated monomers which may be used to form the host macroporous copolymer.

The suitable monoethylenically unsaturated monomers containing a functional group which can be converted to a weak basic group are monoethylenically unsaturated monomers containing haloalkyl groups. Such haloalkyl groups include, but are not limited to, chloromethyl and/or bromomethyl. The groups will be attached to the monoethylenically unsaturated portion of the monomer, as in for example, p-vinyl benzyl chloride (VBC). Thus, for example, the crosslinked guest precursor copolymer may be formed by polymerization of VBC and divinylbenzene to form a guest precursor copolymer having pendant chloromethyl groups.

Methods for preparing the host macroporous copolymer are known in the art. See for example U.S. Pat. Nos. 3,275,548 and 3,357,158.

The hybrid resin useful in the process of the present invention in which the pores of the macroporous host copolymer are filled with a crosslinked guest copolymer are prepared by adding a monomer mixture containing the components necessary to form the crosslinked guest precursor copolymer to a suspension of the host macroporous precursor copolymer in water. While not intending to be bound by a particular theory, it is believed that the monomer is adsorbed or imbibed into the pores of the macroporous copolymer and the imbibed monomers are polymerized within the macroporous host copolymer beads by heating the mixture. Thereafter, the ion necessary functional groups are introduced to create the internal zwitterions relationship. Referring to the FIG. 1, this may be done by treating the hybrid resin with a weak base such as dialkyl amine to convert the haloalkyl groups to amine groups, and by hydrolysis to convert the preferred carboxylic ester groups, or other protected weak acid functionalities, on the host precursor copolymer to weak acid groups.

Since the guest copolymer is held within the pores of the host copolymer, the respective weak base and weak acid groups are in proximity and they thus can form internal zwitterions. When loaded with a salt comprising a cation and an anion, the cation and anion of the salt associate with the respective weak base and weak acid groups, thus, replacing the interaction of the zwitterions. Since no ion exchange takes place, thermal removal of the adsorbed salt may be accomplished at relatively moderate temperatures, typically in the range of about 60-100° C.

The formation of the crosslinked guest precursor copolymer in the presence of the macroporous host precursor copolymer is a polymerization generally carried out in the presence of a catalyst. Suitable catalysts include those which provide free radicals to function as reaction initiators include benzoylperoxide, t-butyl hydroperoxide, lauroyl peroxide, cumene hydroperoxide, tetralin peroxide, acetyl peroxide, caproyl peroxide, t-butyl perbenzoate, t-butyl diperphthalate, methyl ethyl ketone peroxide.

The amount of peroxide catalyst required is roughly proportional to the concentration of the mixture of monomers. The usual range is 0.01% to 5% by weight of catalyst with reference to the weight of the monomer mixture. The optimum amount of catalyst is determined in large part by the nature of the particular monomers selected, including the nature of the impurities that may accompany the monomers.

Another suitable class of free-radical generating compounds which can be used as catalysts includes the azo catalysts, including for example, azodiisobutyronitrile, azodiisobutyramide, azobis(α,α-dimethylvaleronitrile), azobis(a-methyl-butyronitrile), dimethyl, diethyl, or dibutyl azobis(methyl-valerate). These and other similar azo compounds, which serve as free radical initiators, contain an —N═N— group attached to aliphatic carbon atoms, at least one of which is tertiary. An amount of 0.01 to 2% of the weight of monomer or monomers is usually sufficient.

Conditions for forming the guest precursor copolymer in the presence of the host macroporous precursor copolymer are known in the art. Typically the polymerization to form the guest precursor copolymer is conducted in a liquid, such as water that is not a solvent for monomeric material. However, a precipitant must also be present which acts as a solvent for the monomer mixture but which is chemically inert under the polymerization conditions. The presence of the precipitant causes a phase separation of the product hybrid copolymer. The determination and selection of such precipitants are known in the art.

The relative amounts of guest precursor polymer and MP host precursor copolymer can be varied over a wide range. It is desirable, however, to use at least 50 parts by weight of guest precursor copolymer per 100 parts by weight of MP base or host precursor polymer, with the maximum amount being dictated by that amount which can be imbibed or retained in or on the MP structure. This maximum will ordinarily be about 300 parts by weight of guest precursor copolymer per 100 parts by weight of base precursor polymer, although higher amounts can also be used. Preferably, the amounts of guest precursor copolymer to MP base will be in the range of about 100 to 200 parts of guest precursor copolymer per 100 parts of MP polymer.

The resins according to the present invention may be used to remove the salts from an aqueous solution. Thus the hybrid resins have use for deionizing water, desalination, desalting urine to a level where it may be used directly as a hydrogen source for plants, purification for water regeneration on space vehicles, decolorizing sugar solutions, and decontaminating or purifying industrial waste water.

The hybrid resins will be contacted with the liquid containing the salts to be removed at temperature range, typically from about 5° C. to 25° C. To regenerate the hybrid resin, that is, to remove the cations and anions associated with the adsorbed salt from the resin, the resin will be contacted with or flushed with an aqueous liquid at a higher temperature, typically in the range of about 60-100° C.

It is an advantage of the invention that upon formation of the guest copolymer in the presence of the host macroporous copolymer, that conversion to the functional weak base groups does not require a haloalkylation step. Haloalkylation is a somewhat dangerous process, particularly when performed on a large scale, thus the synthesis of the hybrid resin is greatly simplified compared to methods of the prior art in which either the host macroporous copolymer or the guest crosslinked copolymer are haloalkylated after polymerization.

It is a further advantage of the present invention, and which is unexpected, that capacities of the resins of the invention are greatly improved over similar host-guest hybrid resins known in the art.

The following examples will further illustrate the invention but are not intended to limit it. In the present application, parts and percentages are given by weight unless otherwise stated.

### EXAMPLE 1

Resins according to the present invention were compared to a commercial thermally regenerable resin AG MP-1 made by Bio-Rad and a known thermally regenerable resin, identified as GR-40. The resin GR-40 and the resins according to the present invention tested below all use the same macroporous host copolymer, XE275 (Rohm and Haas) which is formed by polymerization of an acrylic ester with divinyl benzene under conditions which form a macroporous crosslinked copolymer. The following steps were used to form a resin according to the present invention identified as resin 23 AHH:
1. Stir mixture of 10 g Rohm and Haas copolymer XE-275(host polymer) in 50 cc water and 1 g Igepon-42 surfactant
2. Make mixture of 10 g vinylbenzyl chloride monomer, 0.7 g of 55% divinylbenzene, 4.3 g methyl isobutyl carbinol, and 1 g benzoyl peroxide (guest monomer mixture).
3. Add mixture from (2) dropwise to stirred polymer slurry from (1) to imbibe (2) into (1)
4. Heat to 80 C to polymerize mixture (2) inside the XE-275 beads
5. Pour off liquid and add 155 ml 40% dimethyl amine
6. Heat to 45 C to aminate chloride groups on vinyl benzene
7. Pour off liquid and add 20 ml water and 20 ml 1N KOH
8. Heat at 95 C for 1 hour to hydrolyze alcohol groups on XE-275 polymer
9. Pour off liquid and rinse to conductivity of approximately 25 μS
10. Titrate with continuous stirring, using 1N HCl to pH approximately 5.3
11. Regenerate in boiling water to conductivity of ca. 250 μS when hot, ca. 20 μS at room temperature

Other resins according to the present invention, 36A and 27D were made with the modifications as indicated below. Each of the resins was tested in 40 cc batches. Breakthrough curves were generated using a 500 mg/L sodium chloride solution, which is close to the high salt content of composite potable water. The flow rates used in the tests were identical in each case, and the minutes to breakthrough of the salt (determined when 5 to 10 ppm was detected in the effluent). Similarly, the time to 50% breakthrough, defined as detection of the salt in the effluent at 250 ppm. The results are given in the table below.

| Sample | Min. to BT¹ | Min to 50% BT² |
|---|---|---|
| Bio-Rad³ | 2.5 | 4 |
| GR 40⁴ | 4 | 36 |
| 23 AHH⁵ | 72 | 150 |
| 36 A⁶ | 84 | 154 |
| 27 B⁷ | 108 | 153 |

¹Breakthrough of salt, ie 5-10 ppm
²Breakthrough of salt at 250 ppm
³Commercial resin
⁴A known resin composed of XE-275 host copolymer; guest monomer mix:styrene, divinyl benzene, methyl isobutyl carbinol; guest monomer mix host polymer ratio = 1:1.
⁵Guest monomer mix:host polymer ratio = 1:1. See procedure below, Example 3.
⁶Same as 23 AHH except that DVB in monomer mix reduced by 50%.
⁷Same as 23 AHH except that MIBC in monomer mix reduced by 50%.
As can be seen from the table, the resins according to the present invention exhibit a substantial salt removal capacity.

### EXAMPLE 2

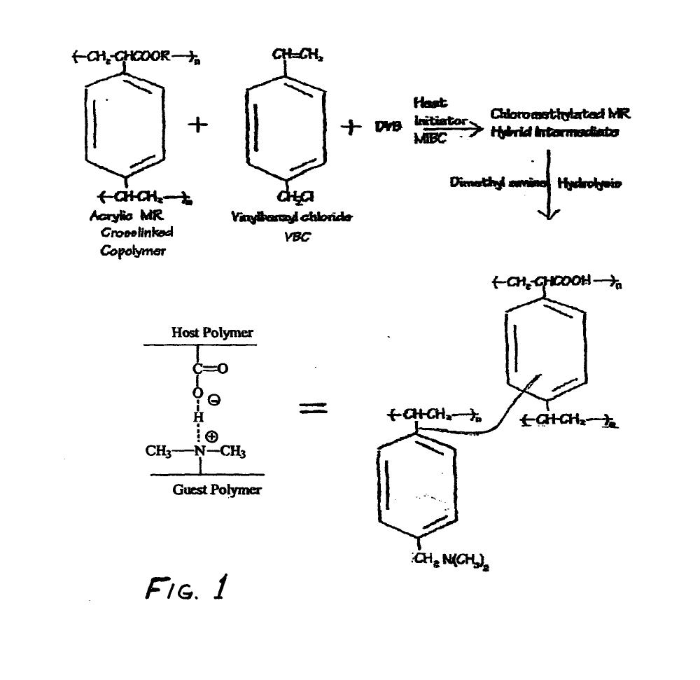

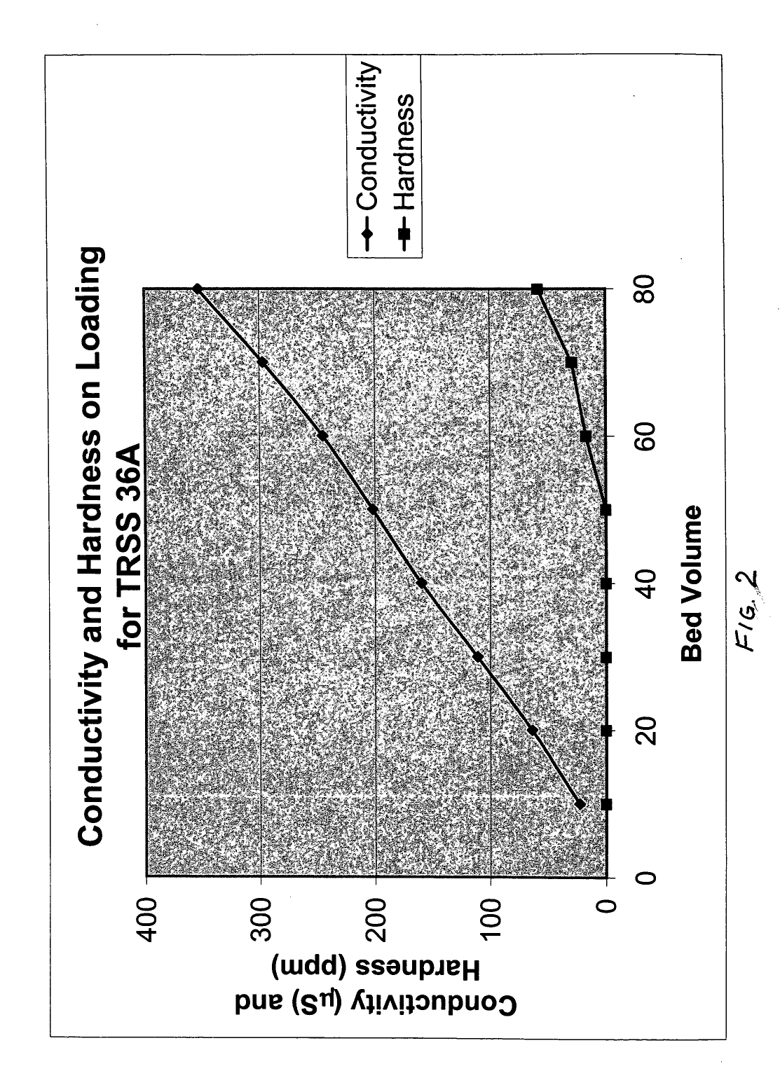

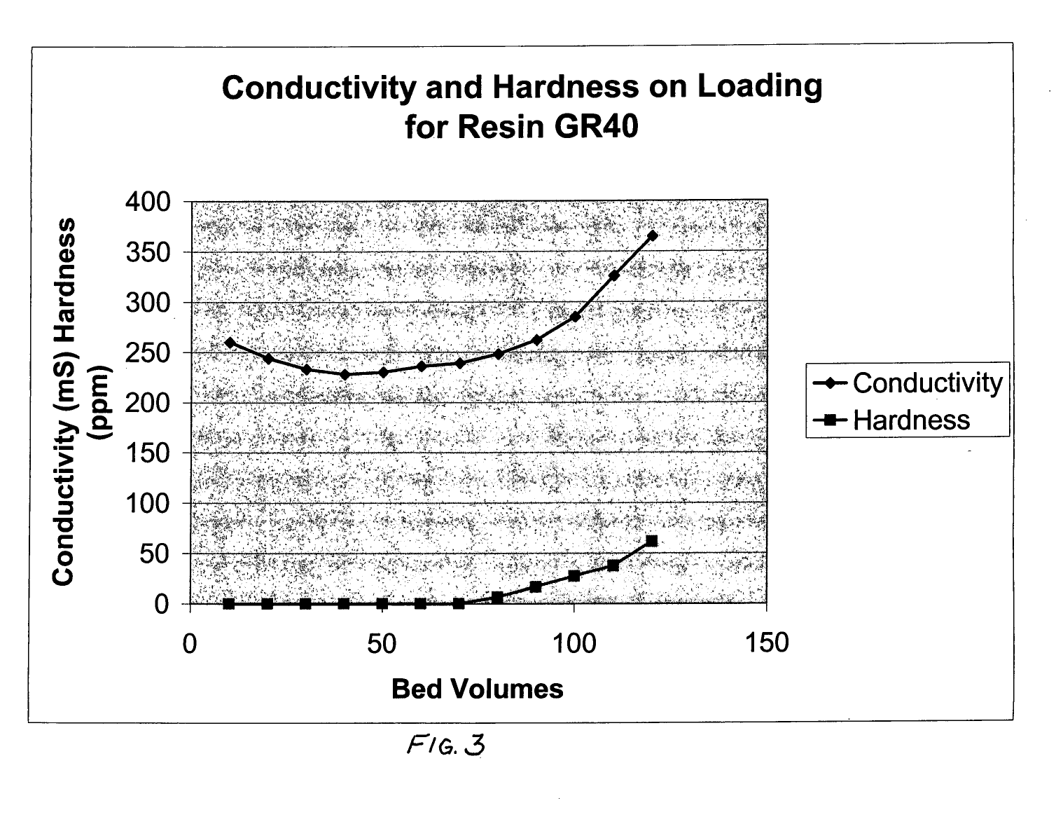

Resins of the prior art, such as GR40, are known to be too selective for calcium and magnesium ions in that regeneration with water at 95° C. is incomplete, thus rendering them commercially unacceptable. In contrast, a resin according to the invention, TRSS 36A, is less selective for calcium and magnesium ions, therefore, regeneration at 95° is more complete and yields reproducible loading/regeneration cycles that are commercially acceptable in industrial and residential softening applications. The main differences between these resins are shown in FIGS. 2 and 3.

Also, FIGS. 2 and 3 show that the prior art resin has virtually no capacity for sodium ions in the presence of calcium and magnesium ions compared to TRSS 36A which has significant sodium capacity in the presence of these ions. This data indicate that a resin according to the invention is more commercially viable than a prior art resin in desalting applications.

### EXAMPLE 3

Resins according to the invention may also be made as follows:
1. Mix 110 g VBC, 46 g methyl isobutylcarbinol, 8.4 g 55% DVB and 11 g benzoylperoxide for 15 minutes to dissolve the peroxide.
2. Add the mixture from step 1 to 100 g XE-275 in a rolling container and imbibe for a minimum of 3 hrs.
3. Heat the rolling container for a minimum of 1.5 hrs. at 80° C. to polymerize.
4. Transfer to 3-neck flask after passing through 16-mesh sieve.
5. Add 800 ml 1N NaOH and 850 ml 40% dimethylamine.
6. Heat to boiling and reflux 1.5 hr. (about 75° C.).
7. Pour off solution and add fresh 850 ml 1N NaOH and heat at 90° C. for 1.5 hr.
8. Pour off liquid and rinse resin with deionized water to conductivity of 200.
9. Acidify with 1N HCl by adding acid at such a rate that pH does not go below 4 until a stable (for 1 hr) end point of pH 5.30 is reached. This normally takes several hours and about 550 ml 1N HCl.

Yield: about 500 ml finished resin.

1. A heterogenous hybrid resin having two relatively independent phases comprising:
a crosslinked macroporous host copolymer phase formed from a polyunsaturated monomer and a monoethylenically unsaturated monomer containing a functionality convertible to a weak acid;
said macroporous host copolymer being at least partially filled in the macropores thereof with a crosslinked guest copolymer phase formed from a polyunsaturated monomer and a monoethylenically unsaturated monomer containing a haloalkyl group.

2. A hybrid resin according to claim 1 wherein said haloalkyl group comprises a chloroalkyl group.

3. A hybrid resin according to claim 2 wherein said chloroalkyl group comprises a chloromethyl group.

4. A hybrid resin according to claim 1 wherein said polyunsaturated monomer containing a functionality convertible to a weak acid comprises an acrylic ester.

5. A method of forming a precursor for a heterogenous thermally regnerable salt sorbent having two relatively independent phases comprising the step of forming a crosslinked copolymer by polymerization of a polyunsaturated monomer and a monoethylenically unsaturated monomer containing a haloalkyl group in the presence of a macroporous copolymer, said macroporous copolymer formed from a polyunsaturated monomer and a monoethylenically unsaturated monomer containing a functionality convertible to a weak acid.

6. A method according to claim 5 wherein said haloalkyl group comprises a chloroalkyl group.

7. A method according to claim 6 wherein said chloroalkyl group comprises a chloromethyl group.

8. A method according to claim 5 wherein said monoethylenically unsaturated monomer containing a functionality convertible to a weak acid comprises an acrylic ester.

9. A method according to claim 5 wherein said polyunsaturated monomer comprises divinylbenzene.

10. A method according to claim 5 wherein said monoethylenically unsaturated monomer containing a haloalkyl group comprises vinylbenzyl chloride.

11. A method for forming a heterogenous thermally regenerable salt sorbent resin having two relatively independent phases comprising the steps of:
(a) treating a heterogenous hybrid resin having two relatively independent phases, said heterogenous hybrid resin comprising a crosslinked macroporous host copolymer phase formed from a polyunsaturated monomer and a monoethylenically unsaturated monomer containing a functionality convertible to a weak acid, said macroporous host copolymer being at least partially filled in the macropores thereof with a crosslinked guest copolymer phase formed from a polyunsaturated monomer and a monoethylenically unsaturated monomer containing a haloalkyl group with a weak base to thereby at least partially convert said haloalkyl groups to weak base groups to form a heterogenous hybrid weak base resin;
(b) treating said heterogenous hybrid weak base resin with a hydrolyzing agent to thereby at least partially convert said functionalities convertible to weak acids to weak acid groups to form said heterogenous hybrid thermally regenerable salt sorbent resin having two relatively independent phases, one phase comprising a macroporous host copolymer having said weak acid groups and the other phase comprising a crosslinked guest copolymer having said weak base groups.

12. A method according to claim 11 wherein said haloalkyl groups comprise chloroalkyl groups.

13. A method according to claim 12 wherein said chloroalkyl comprise chloromethyl groups.

14. A method according to claim 11 wherein said monoethylenically unsaturated monomer containing a functionality convertible to weak acid comprises an acrylic ester.

15. A method according to claim 11 wherein said monoethylenically unsaturated monomer containing halo alkyl groups comprises vinylbenzyl chloride.

16. A method according to claim 11 wherein said weak acid groups comprise carboxylic acid groups.

17. A method according to claim 11 wherein said weak base groups comprise dialkylamine groups.

18. A method according to claim 17 wherein said dialkylamine groups comprise dimethylamine groups.

19. A method of treating an aqueous fluid to substantially reduce the concentration of dissolved salts contained therein, comprising the steps of:
(a) contacting said aqueous fluid within a first temperature range with a mass of thermally regenerable hybrid salt sorbent resin having two relatively independent phases comprising a first phase comprising a host macroporous copolymer of a polyunsaturated monomer and a monoethylenically unsaturated monomer containing weak acid groups and further comprising a second phase comprising a crosslinked guest copolymer of a polyunsaturated monomer and a monoethylenically unsaturated monomer containing weak basic groups; wherein the pores of said host macroporous copolymer of said first phase are at least partially filled with said guest copolymer of said second phase; and
(b) regenerating said hybrid salt sorbent resin by elution with an aqueous regenerant fluid within a second temperature range wherein said second temperature range is greater than said first temperature range.

20. A method according to claim 19 wherein said first temperature range is about 5° C. to 25° C.

21. A method according to claim 19 wherein said second temperature range is about 60° to 100° C.

22. A method according to claim 19 wherein said weak base groups comprise a dialkyl amine.

23. A method according to claim 22 wherein said dialkyl amine comprises dimethylamine.

24. A method according to claim 19 wherein said weak acid groups comprise a carboxylic acid group.

25. A method according to claim 19 wherein said polyunsaturated monomer comprises divinylbenzene.
